(19) United States
(12) Patent Application Publication
(10) Pub. No.: US 2023/0014818 A1
(43) Pub. Date: Jan. 19, 2023

(54) Paper Straw and Method of Fabricating the Same

(71) Applicant: Chi Wing Don Wan, Kowloon (HK)

(72) Inventor: Chi Wing Don Wan, Kowloon (HK)

(21) Appl. No.: 17/865,061

(22) Filed: Jul. 14, 2022

(30) Foreign Application Priority Data
Jul. 15, 2021 (HK) 32021035072.6

(51) Int. Cl. A47G 21/18; B31D 5/00

(52) U.S. Cl. CPC A47G 21/18; B31D 5/0095

(57) ABSTRACT

A paper straw is formed by rolling a sheet into a tubular shape, and the sheet has a substantially elongated shape which defines a first end and a second end of the sheet. The first end of the sheet has an uneven shape, such that a straw end of the paper straw corresponding to the first end of the sheet has a non-circular cut. By preparing the paper sheets in a dedicated shape and/or dimension, with pre-cut patterns formed on the end(s) of the sheet, there is no cutting needed after the sheet is wrapped around and forms the paper straw.

### FIELD OF INVENTION

The present invention relates to the field of beverage products, and in particular to paper straws.

### BACKGROUND OF INVENTION

Paper straws in recent years have been widely accepted by catering industries around the world because compared to traditional plastic straws, paper straws are environmentally friendly and some of them are even bio-degradable. The manufacturing process of paper straws is also known to be substantially different from that of plastic straws, where paper straws are fabricated often by rolling a paper sheet along a spiral direction.

However, while the traditional paper straw manufacturing process may be suitable for making the most common straws with flat shapes (i.e. circular cut) at the two ends, it poses technical difficulties to manufacture special-shape straws such as when one or both ends of the paper straws has a spoon shape or a sharp shape. Conventionally, extra machines/extra production steps are required to cut the normal paper straws into special shapes after straw formation, but such cutting easily leads to paper burrs at straw end(s) because of the cutting performed on the straw. In addition, the extra machines or production steps no doubt result in additional cost of production.

### SUMMARY OF INVENTION

In the light of the foregoing background, it is an object of the present invention to focuses on the above-mentioned weakness and propose alternative paper straw manufacturing method in particular for special-shape straws.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

According to an aspect of the present invention, a paper straw is formed by rolling a sheet into a tubular shape, and the sheet has a substantially elongated shape which defines a first end and a second end of the sheet. The first end of the sheet has an uneven shape, such that a straw end of the paper straw corresponding to the first end of the sheet has a non-circular cut.

In some embodiments of the invention, the first end of the sheet has a symmetrical shape about a virtual line parallel to and equidistant from two side edges of the sheet. The two side edges run along the longitudinal direction. The first end contains two portions as separated by the virtual line.

In some embodiments of the invention, the straw end is sharp so that it is adapted to penetrate a film of a beverage container.

In some embodiments of the invention, each of the two portions further contains an inwardly converging edge such that the inwardly converging edges of the two portions together form an angle pointing to the second end.

In some embodiments of the invention, each of the two portions further contains edges forming an angle pointing to the second end.

In some embodiments of the invention, the first end contains multiple linear edges which together form the uneven shape.

In some embodiments of the invention, the straw end forms a spoon.

In some embodiments of the invention, each of the two portions further contains a substantially bell-shaped edge that protrudes outwardly away from the second end.

In some embodiments of the invention, the first end of the sheet includes a substantially bell-shaped edge that protrudes outwardly away from the second end.

In some embodiments of the invention, a width of the bell-shaped edge is smaller than a width of the sheet near the second end.

According to another aspect of the invention, there is provided a method of fabricating a paper straw, which contains the steps of providing a sheet having a substantially elongated shape; and rolling the sheet equally along its length so that the roll shape can be formed. The sheet contains a first end and a second end, and the first end of the sheet having an uneven shape, such that a straw end of the paper straw corresponding to the first end of the sheet has a non-circular cut.

Embodiments of the invention therefore provide improved paper straw manufacturing methods that can be used for manufacturing special-shape straws such as those with a spoon end or a sharp end. By preparing the paper sheets in a dedicated shape and/or dimension, with pre-cut patterns formed on the end(s) of the sheet, there is no cutting needed after the sheet is wrapped around and forms the paper straw. Such a pre-cutting process done on the paper sheet brings advantages that there is no need for extra machines/extra production steps to cut straws into special shapes after straw formation, as compared to the manufacturing equipment/method for typical cylindrical straws. In addition, as the paper sheet is pre-cut with the specific patterns there will be no paper burr at straw ends that is otherwise formed if the paper straw is cut post-formation. The cost of making the special-shape straws is therefore controlled to be consistent with that of cylindrical straws.

### BRIEF DESCRIPTION OF THE DRAWINGS

Accompanying drawings are for providing further understanding of embodiments of the disclosure which form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a front view of the paper sheet used to manufacture a paper straw with a sharp end, according to a first embodiment of the invention.

FIGS. 2a-2c are respectively a front view, a side view and a rear view of the paper straw manufactured using the paper sheet of FIG. 1.

FIG. 2d is a perspective view of a portion of the paper straw in FIGS. 2a-2c.

FIG. 3 is a front view of the paper sheet used to manufacture a paper straw with a sharp end, according to a second embodiment of the invention.

FIG. 4 is a front view of the paper sheet used to manufacture a paper straw with a sharp end, according to a third embodiment of the invention.

FIGS. 5a-5c are respectively a front view, a side view and a rear view of the paper straw manufactured using the paper sheet of FIG. 4.

FIG. 5d is a perspective view of a portion of the paper straw in FIGS. 5a-5c.

FIG. 6 is a front view of the paper sheet used to manufacture a paper straw with a sharp end, according to a fourth embodiment of the invention.

### DETAILED DESCRIPTION OF PREFERRED EMBODIMENTS

In order to make the technical solution of the present invention better understandable by a person skilled in the art, technical solutions in the embodiments of the present invention are clearly and integrally described in the following with reference to the accompanying drawings in the embodiments of the present invention. Apparently, the described embodiments are merely part of the embodiments of the present invention, but not all of the embodiments. All other embodiments obtained by a person skilled in the art based on the embodiments of the present invention without departing from the inventive scope should fall within the scope of the present invention.

It should be noted that the terms “first”, “second”, and the like in the description, claims, and figures of the present invention are used to distinguish similar objects, and are not necessarily used to describe a particular order or precedence order. It is to be understood that the materials so used here are interchangeable where appropriate, so that the embodiments of the invention described herein can be implemented in a sequence other than those illustrated or described herein. Moreover, the terms “comprises” and “comprising” and any variations thereof are intended to cover a non-exclusive inclusion.

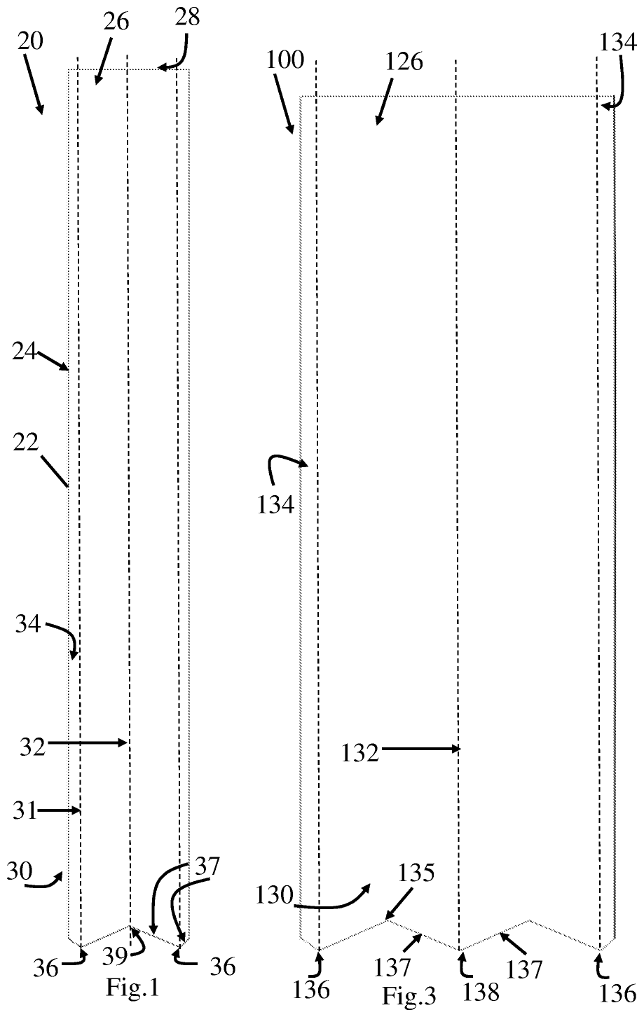

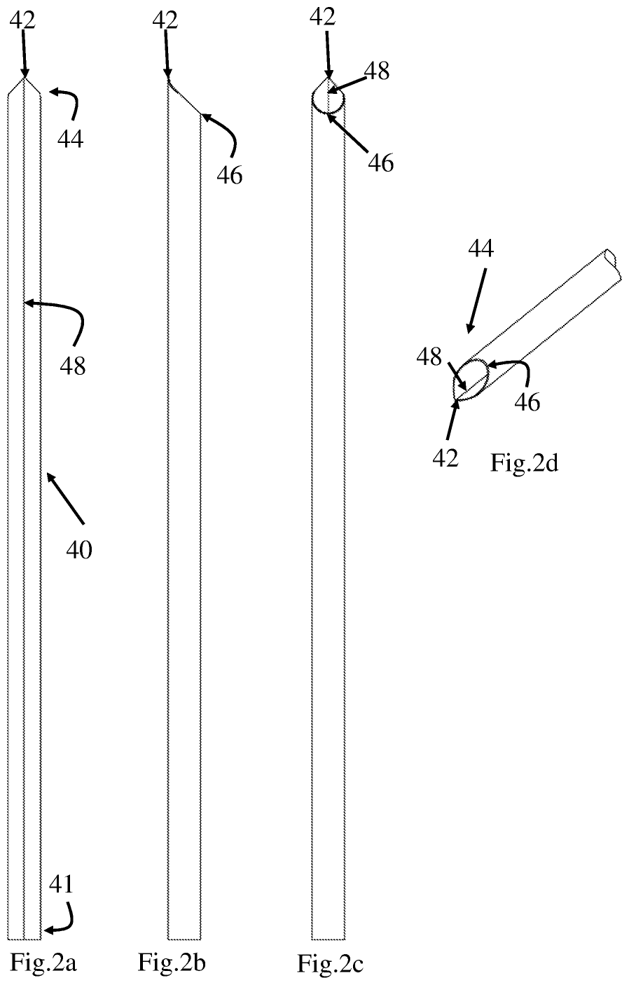

FIG. 1 is a front view of a paper sheet 20 according to a first embodiment of the invention, where the sheet 20 is suitable for making a paper straw 40 (see FIGS. 2a-2d) that has a special shape at its one end 44. The sheet 20 has an elongated shape as shown in FIG. 1 and contains two side edges 24. The two side edges run along the longitudinal direction (not shown) of the sheet 20 and are parallel to each other. Because of its elongated shape, the sheet 20 has a first end 30 and a second end 26. The second end 26 of the sheet 20 has a square shape and contains a bottom edge 28 that is used to form the flat end (with a circular cut) of the straw 40 when the sheet 20 is wrapped to form the straw 40. The bottom edge 28 is perpendicular to the two side edges 24. It should be noted that by saying “square shape” it does not mean that there is any relationship between the length of the bottom edge 28 and the lengths of the side edges 24. Rather, as long as the bottom edge 28 is perpendicular to the two side edges 24 the resulted shape is considered as a square end.

It should also be noted that the word “cut” when used to describe the shape of the end(s) of the paper straw herein does not mean that the shape is formed by a cutting process to the paper straw. Rather, it means only that the appearance of the end of the straw is similar to the resultant pattern when a long cylindrical straw is cut out to form the end. As will be mentioned in more details below, in some embodiments of the invention the cut at the special-shape end of the straw is formed by rolling a pre-cut paper sheet to form the special shape.

The paper sheet 20 contains a trunk portion 22 that connects the second end 26 and the first end 30, and a length of the trunk portion 22 determines that of the paper straw 40. Part of the trunk portion 22 adjacent to the side edges 24 is intended to be used as welding regions 34 each of which is delimited by a side edge 24 and a corresponding welding boundary 31.

The first end 30 has an uneven shape, unlike the second end 26 and its bottom edge 28. In particular, the first end 30 contains multiple linear edges 37 which together form the uneven shape. As shown in FIG. 1, there are four linear edges 37 at the first end 30 and these linear edges 37 are connected in a head-to-toe manner which together form a substantial zig-zag shape. It should be noted that the first end 30 has a symmetrical shape about a virtual line 32 which is parallel to and equidistant from two side edges 24 of the sheet 20. The first end 30 thus contains two symmetrical portions as separated by the virtual line 32, and each portion contains two linear edges 37 that form an angle 36 pointing away from the second end 26. On the other hand, the linear edge 37 next to the virtual line 32 in each portion is an inwardly converging edge such that the two inwardly converging edges of the two portions together form an angle 39 pointing to the second end 26. In addition, the above-mentioned welding boundaries connects respectively to a tip point of the two angles 36.

During manufacturing of the paper straw 40 from the sheet 20, the sheet 20 is rolled along its width direction (i.e. the direction that the bottom edge 28 extends) so that a closed cylindrical shape of the straw 40 is formed, and the two welding regions 34 overlap with each other completely along the longitudinal direction of the straw 40, where the two welding regions 34 are fixed together using ultrasonic welding techniques. The machine used to roll the paper sheet 20 into the paper straw 40 for example can be the ones described in applicant's Hong Kong patent application 32020006149.9. Details of the machines and the rolling process of the straw will not be described further here.

Turning to FIGS. 2a-2d, the paper straw 40 once rolled from the sheet 20 has a flat end 41 formed by the second end 26 of the sheet 20. The flat end 41 has a circular cut which means that the cross-sectional shape of the cut is a circle. In comparison, the other end of the straw 40 is a sharp end 44 which has a non-circular cut. As can be seen in FIG. 2d and FIG. 2c, the sharp end 44 has a substantially oval cut. The sharp end 44 is formed by the angles 36 at the first end 30 of the sheet 20 as a result of the overlapping of the two welding regions 34, and the angles 36 overlap partially with each other and two adjacent linear edges 37 together form a tip 42 of the sharp end 44. In addition, overlapping of the welding regions 34 resulted in an interface line 48 in the straw 40 that extends to the tip 42. The tip 42 can be used to penetrate the film of a beverage container (e.g. a bubble tea cup or a paper packaged drink) so that the user can drink the beverage in the container through the straw 40.

In the embodiment mentioned above, the straw 40 is rolled from a coated paper strip (sheet) 20 made of coated paper, and the coated paper is a paper-based substrate where a coating layer is formed on one or both sides of the paper-base layer, that is, a single-sided coated paper or a double-sided coated paper. Since the coating layer can be effectively waterproof, the straw can be prevented from softening and collapsing in the beverage for a short time, and the taste of the straw can be maintained, thereby facilitating the use and acceptance by the consumer. The coating layer is made of a biodegradable coated resin.

Next, in FIG. 3 another embodiment of the invention is shown, which similar to the sheet in FIGS. 1-2d is a paper sheet 100 for making a sharp-end straw. For the sake of brevity, any identical or similar structure of the paper sheet or straw in FIG. 3 as well as in other drawings thereafter as compared to the embodiment in FIGS. 1-2d will not be described in details, but only their differences will be introduced. In FIG. 3, a first end 130 of the sheet 100 again has an uneven shape, and in particular a zig-zag shape. Nonetheless, the two portions of the first end 130 as divided by the virtual line 132 each has two angles formed including an angle 36 pointing away from the a second end 126 of the sheet 100, and in addition another angle 135 pointing toward the second end 126. Still, at the virtual line there is an angle 138 pointing outwardly away from the second end 126, which is formed by two linear edges 137 of the two portions connecting the virtual line 132. Because of the two outwardly pointing angles 136 and the single outwardly pointing angle 138 at the first end 130, the paper straw (not shown) formed by the sheet 100 will have two tips at the sharp end, whereas the paper straw 40 in FIGS. 2a-2d has only one tip.

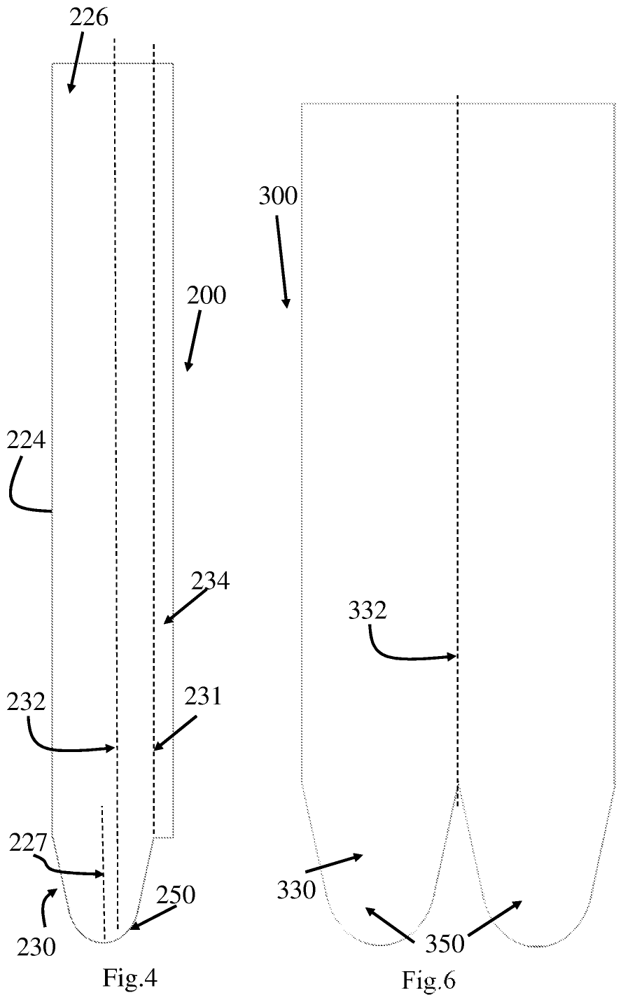

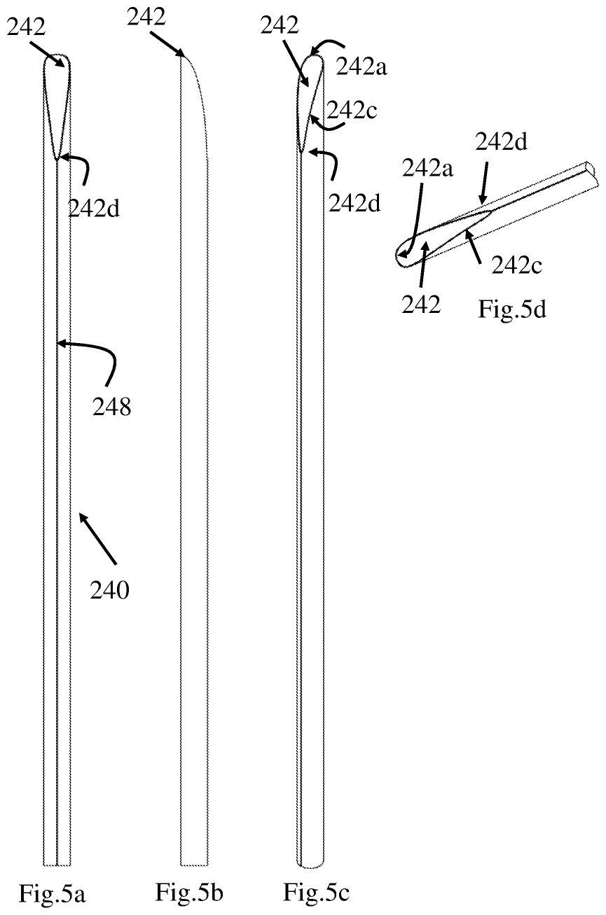

Turning to FIGS. 4-5d, in a further embodiment of the invention a paper sheet 200 has a first end 230 that has a special shape. The first end 230 does not contain linear edges as in FIGS. 1-3, but instead the first end 230 contains a bell-shaped edge 250 which protrudes away from a second end 226 of the sheet 220. The bell shape itself is symmetrical along a central axis 227, which is offset from the virtual line 232 that is equidistant from the two side edges 224. In other words, the bell shape at the first end 230 is not symmetrical about the virtual line 232. As such, a width of the bell-shaped edge 250 is smaller than a width of the sheet 200 near the second end 226. As can be seen in FIG. 4, a welding boundary 231 is present on only one side of the sheet 200 which defines a welding region 234.

By rolling the sheet 200 using the process similar as mentioned above, the outcome is a paper straw 240 that has a spoon portion 242 on one end, and a flat end on another end. The spoon portion 242 has a non-circular cut, and includes a tip portion 242a, a concave point 242d, and two curved edges 242c extending between the tip portion 242a and the concave point 242d. The tip portion 242a is the front end of the spoon. The tip portion 242a is located in the lower half of the straw 240 relative to the longitudinal axis of the straw 240, and the concave point 242d is located in the upper half of the straw relative to the longitudinal axis of the straw 240.

Turning to FIG. 6, another embodiment of the invention is a paper sheet 300 which similar to the sheet in FIGS. 4-5d is a paper sheet for making a spoon-end straw. Compared to the paper sheet in FIG. 4, the paper sheet 300 has a first end 330 of the sheet 100 again has an uneven shape, but the two portions of the first end 330 as divided by the virtual line 332 each has a bell-shaped edge 350. Because of the bell-shaped edges 350, the paper straw (not shown) formed by the sheet 300 will have two spoon portions at the same end, whereas the paper straw as shown in FIGS. 5a-5d has only one spoon portion.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It is to be understood that, if any prior art publication is referred to herein, such reference does not constitute an admission that the publication forms a part of the common general knowledge in the art, in Australia or any other country.

In the embodiments introduced above, an end of the straw may have a shape of angle cut/spoon. However, those skilled in the art would realize that the end of both ends of a straw may be formed in any other shape according to practical applications, and to achieve such shape the paper sheet for rolling will be designed to be in a particular shape (i.e. pre-cutting), such that once the straw is formed there is no need for any cutting again.

In addition, those skilled in the art should realize that the length of the straw can be cut according to different requirements, and in any event as mentioned above and end of the straw can be formed as a special shape to meet different requirements. Moreover, the embodiments mentioned above show paper straws with only one end being a special end, and the other end is a traditional flat end. Those skilled in the art should understand that if needed, both ends of the paper straw can be made special shapes using processes introduced by embodiments of the invention.

In the embodiments mentioned above, an interface side of two edges of a rolled coated paper may extend in the direction of extension of the longitudinal axis of the straw, i.e., in parallel with respect to the longitudinal axis (no matter if the longitudinal axis of the straw is straight or curved), or may extend in a spiral shape in the direction of extension of the longitudinal axis of the straw. This depends on the rolling equipment and the rolling process. The shape of the entire paper sheet in those circumstances may also be different from a perfect elongated shape, but extend transversely at different points along the length of the sheet.

The technique mentioned for attaching two sides of the paper sheet after wrapping up in embodiments described is the ultrasonic welding. However, those skilled would understand that it is also possible to use other techniques to attach the two sides for example by using adhesives.

1: A paper straw formed by rolling a sheet into a tubular shape, characterized in that:
the sheet has a substantially elongated shape which defines a first end and a second end of the sheet; and
the first end of the sheet having a symmetrical shape about a virtual line parallel to and equidistant from two side edges of the sheet, wherein the two side edges run along the longitudinal direction; the first end comprising two portions as separated by the virtual line; each of the two portions further comprising edges forming an angle pointing to the second end, such that a straw end of the paper straw corresponding to the first end of the sheet has a non-circular cut.

2: The paper straw of claim 1, where the first end comprises multiple linear edges which together form the symmetrical shape.

3: A paper straw formed by rolling a sheet into a tubular shape, characterized in that:
the sheet has a substantially elongated shape which defines a first end and a second end of the sheet; and
the first end of the sheet having an uneven shape, such that a straw end of the paper straw corresponding to the first end of the sheet has a non-circular cut, wherein the straw end forms a spoon.

4: The paper straw of claim 3, wherein the first end of the sheet having a symmetrical shape about a virtual line parallel to and equidistant from two side edges of the sheet, wherein the two side edges run along the longitudinal direction; the first end comprising two portions as separated by the virtual line; each of the two portions further comprising a substantially bell-shaped edge that protrudes outwardly away from the second end.

5: A paper straw formed by rolling a sheet into a tubular shape, characterized in that:
the sheet has a substantially elongated shape which defines a first end and a second end of the sheet; and
the first end of the sheet having an uneven shape, such that a straw end of the paper straw corresponding to the first end of the sheet has a non-circular cut; wherein the first end of the sheet comprises a substantially bell-shaped edge that protrudes outwardly away from the second end.

6: The paper straw of claim 5, wherein a width of the bell-shaped edge is smaller than a width of the sheet near the second end.

7: A method of fabricating a paper straw, comprising the steps:
a) providing a sheet having a substantially elongated shape; and
b) rolling the sheet equally along its length so that the roll shape can be formed;
characterized in that:
the sheet comprising a first end and a second end, and the first end of the sheet having an uneven shape; the first end of the sheet having a symmetrical shape about a virtual line parallel to and equidistant from two side edges of the sheet, wherein the two side edges run along the longitudinal direction; the first end comprising two portions as separated by the virtual line; each of the two portions further comprising edges forming an angle pointing to the second end, such that a straw end of the paper straw corresponding to the first end of the sheet has a non-circular cut.
